(19) United States
(12) Patent Application Publication
(10) Pub. No.: US 2006/0053113 A1
(43) Pub. Date: Mar. 9, 2006

(54) Method and system for allocating shared resources between applications

(75) Inventor: Christian Hentschel, Cottbus (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/527,861

(22) PCT Filed: Aug. 8, 2003
(86) PCT No.: PCT/IB03/03573

§ 371 Date: Mar. 16, 2005

(30) Foreign Application Priority Data
Sep. 20, 2002 (EP) 02078894.9

(51) Int. Cl. G06F 17/30

(52) U.S. Cl. 707/10

(57) ABSTRACT

On resource limited platforms a set of scalable and non-scalable algorithms may run to enable different applications concurrently, while using all available programmable resources. One of the applications may have the main user attention (user focus), but there is no mechanism to automatically or manually adapt the output quality to the application with user focus. The present invention provides a solution by means of a method and a corresponding system for allocating shared resources between applications with media information on a resource limited platform. The method comprises the steps of identifying an application with a current focus of a user; setting or increasing the output quality of the application with the current focus of the user; and automatically allocating a remaining part of the resources to at least one application without the current focus of the user.

This invention relates to a method and a corresponding system of allocating shared resources between applications with media information on a resource limited platform. Additionally, the invention relates to a computer-readable medium comprising a program, which may cause a computer to perform the method of the present invention.

Real-time media processing is increasingly performed on programmable architectures due to their openness and flexibility. The drawback is that programmable components are more expensive compared with dedicated hardware and therefore the programmable components should be used in the most efficient way. One solution is to use scalable media algorithms in combination with dynamic resource management. These scalable algorithms provide resource scalability in exchange with output quality. Resources maybe CPU cycles, time, memory, bandwidth, co-processors, etc.

On resource-limited platforms, a set of scalable and non-scalable algorithms may be running concurrently to enable an application like watching a movie, browsing through the Internet, etc. As long as only one application is running, all available resources can be spent to ensure the highest possible quality for a given platform. The quality optimisation is part of the overall system control. After opening other applications in a second or more picture-in-picture window (PiP-window), the available resources must be shared, and a reoptimisation of the overall system has to be performed, which again is part of the overall system control and not actively controllable by the user.

EP 1 187 019 discloses a method of resolving conflicts in the allocation of a shared resource between applications. Resources referred to are hardware devices or hardware components such as display, sound system, memory devices, hard disk drive. EP 1 187 019 relates to a so-called focus application, which is an application, with which the user is currently interacting, in a multi-application environment. In case of conflicts, when a second application is accessing the same resource (e.g. display, hard disk, sound system, memory devices), then the application with user focus will get the resource, while the other application will be rejected.

However, EP 1 187 019 does not describe sharing of the same resources, like e.g. the display, for more than one application. In stead, all resources are granted to one application having user focus.

Present dynamically adaptable systems do not automatically have information about user focus. It is a problem, that current user interfaces provide no means to inform the dynamically adaptable system about the user focus in a multi-application environment, and that the system therefore is unable to allocate resources to the different applications in a smart way.

These problems are solved, when the method and corresponding system mentioned in the opening paragraph further comprises the following steps: identifying an application with a current focus of a user; setting the output quality of a new application to an appropriate high level, or increasing the output quality of an already running application with the current focus of the user; automatically allocating (a) remaining part(s) of the resource(s) to at least one application without the current focus of the user.

By performing the above steps, no user interaction is necessary for quality optimisation in a system with more than one application running, where the best and adaptive distribution of the available resources is performed taking the user focus into account.

Throughout this description of the invention the term “resource” has a broader meaning compared to EP 1 187 019. In general terms, a resource is a device (e.g. display), component (e.g. CPU, memory, co-processor), or specification (e.g. bus bandwidth, time available) on which the resource management strategies described below can be implemented. One particular example of a resource is processor or microprocessor time. A resource can also be any software component which has a limitation on how other components may access it and which can only process a limited number of applications at the same time.

Throughout this description of the invention the term “active window” is meant to denote a part of a display related to an application, which is currently prioritised by a user. This application is also denoted “application with current focus of a user” or “an application with user focus”. Correspondingly, the term “non-active window” is meant to describe a part of a display with an application without current focus of a user. Finally, the term “opening an application/a window” is meant to cover the action of prioritising the specific application/window, meanwhile the term “closing (down) an application/a window” covers the action of giving the specific application/window a lower priority than one ore more other applications/windows or to end the use of the specific application/window.

When the step of identifying the application with the current focus of the user is selected from at least one of the group of: user controlled, system controlled or externally controlled, the output quality of the application with user focus can be adapted automatically or manually.

In an expedient embodiment, the user controlled step of identifying the application with the current focus comprises one or more of the following steps: selecting a new application as the application with the current focus of the user, when the new application is opened; changing the application with the current focus of the user to an application just switched to upon switching to an already opened application; when the user closes down an application with the current focus, switching to the application with the preceding focus of the user by keeping a record of the order of previously opened applications to indicate their importance in decreasing order, where the most recently opened application has the highest importance. This provides an advantageous way to identify which application is the application with the current focus of the user by way of predetermined settings, when a user interacts with the system.

In another expedient embodiment, the system controlled step of identifying the application with the current focus of the user, is performed by one of the following steps: an automatically changing of the current focus of the user according to a predetermined priority hierarchy of the available applications; keeping a record of the order of previously opened applications to indicate their importance in decreasing order, where the most recently opened application has the highest importance and, switching to the application with the preceding focus of the user when the user closes down an application with the current focus. Hereby there is provided an advantageous way for the system to identify which applications is the application with the current focus of the user by way of predetermined settings, with or without the user interacting with the system. This, of course, requires that the user hands over the control of which application is the application with user focus to the system and that the system takes control rather than awaiting user control.

When a provider of the media information performs the externally controlled identification of the application with the current focus of the user, external persons or systems are allowed to influence the relative importance of the various applications and thereby imposing a user focus on the most important application. An example could be that the relative importance of an application showing a commercial could be increased by externally controlled identification of this application as the one with the current focus of the user. It would also be advantageous if an application with newscasts, either on teletext or as a television or radio broadcast, e.g. in the case of a radioactive leak, a nature catastrophe, etc., externally could be opened and/or given the highest priority, i.e. becoming the application with the current focus of the user.

When the step of setting or increasing the output quality of the application with current focus of the user is performed automatically and with no additional input from the user, or manually changed (increased or decreased) by user interaction by means of a user interface, the allocation of the resources to the applications is performed in a user friendly way. Automatically changing of the output quality of the application with the current focus of a user may work in many cases without additional inputs from a user, but in some cases the user may want to increase or decrease the output quality of the application with user focus manually. In the active window, which has the current focus of the user, this can be done by a user interface, such as a remote control.

In a preferred embodiment of the invention the automatic settings of the overall system control is influenced by a learning function, which averages previous user settings of the past, so that the system can adapt to the preferences of one or more particular users. This has the advantage that the need for user interactions is decreased compared to a system without a learning function. The user preferences can vary over time, which also can be handled by the learning function. The learning function can be implemented as a recursive function, a non-recursive (transversal) function, a non-linear function, a function with different weightings, or any combination. The learning function can include a resetting mechanism, so that a user can cause the learning function to start over again with new settings from future choices by the user.

Additionally, the invention relates to a computer-readable medium comprising a program, which may cause a computer to perform the method of the present invention. A computer-readable medium may e.g. be a CD-ROM, a CD-R, a DVD RAM/ROM, a floppy disk, a hard disk, a smart card, a network accessible via a network connection, a ROM, RAM, and/or Flash memory, etc. or generally any other kind of media that provides a computer system with information regarding how instructions/commands should be executed. Hereby, when a computer is caused to retrieve electronic information—as a consequence of the contents of a computer-readable medium as described above—the advantages mentioned in connection with the corresponding method according to the invention are achieved.

The invention will be explained more fully below in connection with a preferred embodiment and with reference to the drawing, in which:

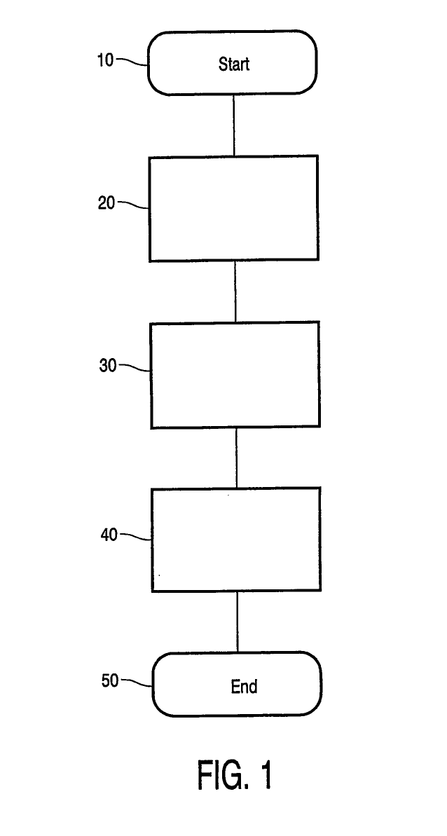

FIG. 1 illustrates a flow diagram of an embodiment of the method according to the invention;

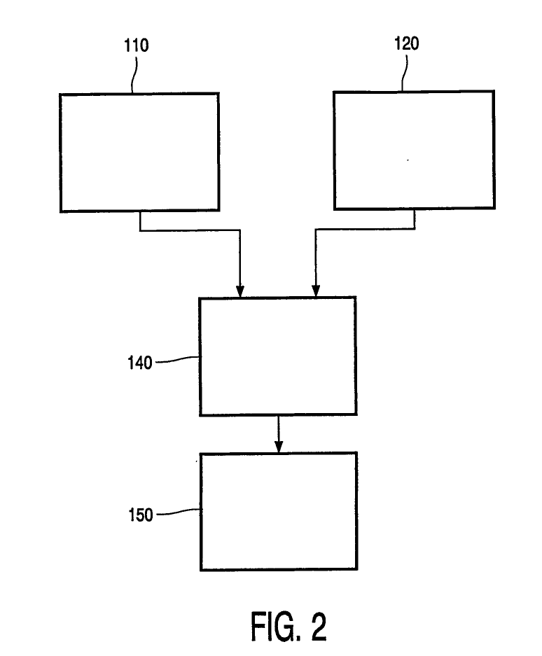

FIG. 2 illustrates a schematic block diagram of components for controlling applications;

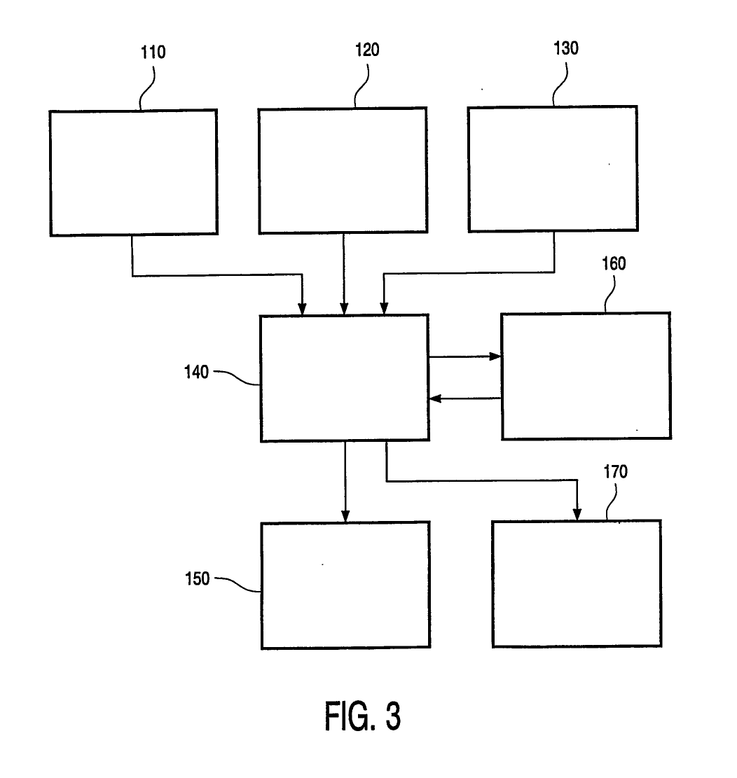

FIG. 3 illustrates an alternative block diagram over components for controlling applications; and

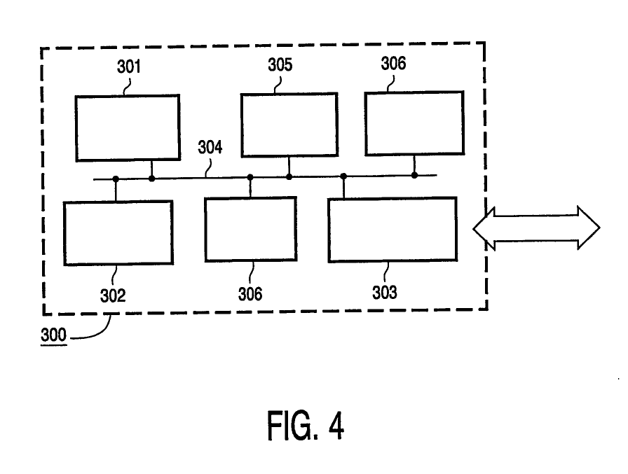

FIG. 4 illustrates a schematic block diagram of a system according to an embodiment of the present invention.

FIG. 1 illustrates a flow diagram of an embodiment of the method according to the invention, wherein the flow starts in step 10 and continues to step 20. In step 20 the application with the current focus of a user is identified which can be user controlled, system controlled or externally controlled.

The user controlled step of identifying the application with the current focus of the user, may comprise one or more of the following steps: selecting a new application as the application with the current focus of the user, when the new application is opened; changing the application with the current focus of the user to an application just switched to upon switching to an already opened application; when the user closes down an application with the current focus, switching to the application with the preceding focus of the user by keeping a record of the order of previously opened applications to indicate their importance in decreasing order, where the most recently opened application has the highest importance.

The System controlled step of identifying the application with the current focus of the user, may be performed by one of the following steps: an automatically changing of the current focus of the user according to a predetermined priority hierarchy of the available applications; keeping a record of the order of previously opened applications to indicate their importance in decreasing order, where the most recently opened application has the highest importance and, switching to the application with the preceding focus of the user when the user closes down an application with the current focus.

The externally controlled step of identifying the application with the current focus of the user may be performed by a provider of the media information.

When the application with the current focus of a user is identified, the process continues to step 30, wherein the output quality of the application with current focus of the user is set to an appropriate level in case of a new application, or changed in case of an already running application. This can be done automatically and with no additional input from the user, or manually by user interaction by means of a user interface.

After setting or changing the quality of the application with the current focus of the user, step 30, the process continues to step 40, wherein the remaining resources, depending on the resource needs of the application with current focus of a user, is allocated to applications, which are running in the background, i.e. without the current focus of a user. The remaining resources are distributed over applications in the background so that the total resource needs remain within the resource limit of the programmable platform. The overall system control should perform this allocation in an automated way.

Of course, other tasks has to be performed, e.g. testing the feasibility of running all applications concurrently, running the applications in the desired way, etc. In the case where all scalable applications are running with their lowest resource use, another application might not be feasible, since in total more resources are required than available on the programmable platform. In the case, where all applications are running concurrently there might not be a possibility for further resource allocations to specific applications. Then it might be necessary to close down one or more applications or to put one or more applications on hold. In this description of the invention, it is presumed that all desired applications are feasible to run in parallel and that sufficient resources can be allocated to the various applications.

FIG. 2 illustrates a schematic block diagram of components for controlling applications containing media information with or without the current focus of a user on resource limited platforms in e.g. a PDA (personal digital assistant), a mobile telephone, at digital TV set, a personal computer, etc. An overall system control 30 is a software component, which is responsible for allocating available resources to different applications and monitoring their functionality. The system control 30 controls the relative importance of the various applications, which could be a television program, browsing through the Internet, a bi-directional videoconference, a baby phone, teletext, etc. As long as only one application is running, the system control allocates all of the available resources to that particular application to ensure the highest possible output quality. When a second application is opened, the system control 140 has to reallocate the available resources depending on the application with the current focus of the user; inputs from a user interface 110 and/or default settings 120.

In some cases a user (not shown) may want to increase or decrease the output quality of an application manually. This can be performed by the user interacting with the system control 140 by means of a user interface 110, such as a remote control, buttons, a keyboard, a keypad, a mouse, etc. It should be noted that these examples of user interfaces are only examples and are not in any way limiting the invention. Future user interfaces with e.g. voice control, eye movement control or even pointing with a finger could be user interfaces within the scope of this invention.

The default settings 120 are sets of programmed instructions for the software regarding which applications take priority above others. An example is an application with a baby phone running in the background and a movie running as the application with user focus. If the baby starts crying, a PiP-window with the baby phone application may pop up. The baby phone application becomes the application with the user focus and the sound may switch to the baby phone application. Hence, the system takes control of which application has the focus of the user without user interaction.

Of course, the user should be able to change the default settings 120 by means of the user interface 110. The combination of the default settings 120 and the user interactions by means of the user interface 110 results in parameter settings 150, which are sets of instructions for the software regarding which application is to be the application with user focus under various conditions.

FIG. 3 illustrates an alternative block diagram over components for controlling applications and includes the measures shown in FIG. 2 and described above. The same features are given the same reference numbers because of simplicity. FIG. 3 illustrates that the system control 140 is influenced by inputs from the user interface 110, the default settings 120, an external control 130 and a smart history memory 160.

The external control 130 can e.g. be performed by means of a set-top box, which can be programmed to vary the perceived output quality of applications running in the system and/or to decide which applications should be the application with the current focus of the user. Hereby, a provider of television programs can influence the relative importance of applications, e.g. increasing the relative importance of an application associated with a commercial or news information making that particular application into the application with the current focus of a user. Of course, the system preferably could be programmed so that the user is able to override the external control.

A smart history memory 160 is a memory storing settings regarding e.g. the order of previously opened windows with applications, or preferred output qualities for the applications input from the system control 140. The smart history memory 160 also acts on the system control 140, for example by inputting information of the order of applications with previous user focus in the case, when an application is closed, so that the application with the previous user focus becomes the applications with the current user focus. The smart history memory 160 can also store a learning function, which averages previous user settings of e.g. particular applications or combinations of applications of the past.

The combination of the default settings 120, the user interactions by means of the user interface 110, and external control 130 input to the system control 140 results in parameter settings 150 as described above in relation to FIG. 2 and optionally in an on screen display 170 of the quality setting for an application with current user focus. The quality setting is preferably shown for a short time at e.g. a bar ranging from lowest to highest quality. Optionally, the quality settings of the applications without the current focus of a user may be displayed as well.

FIG. 4 illustrates a schematic block diagram of an embodiment of a system according to the present invention.

Shown is a system 300 according to the present invention comprising one or more micro-processors 301 connected with a memory/storage 302, co-processors 305, receiving means 303, a display 306 (optional), and one or more loudspeakers 306 (optional) via a communications bus 304 or the like. The memory 302 has firmware, relevant software, rendering engine and/or program instructions, etc. The receiving means 303 is adapted to receive video/audio data and is for example a MPEG-decoder that can decode an MPEG stream received from a data-broadcaster. The received data is stored in the memory means 302 via the bus 304 for processing by the microprocessor means 301. The micro-processor(s) 301 and co-processor(s) 305 (optional) is(are) responsible for deriving the display representation, which is sent to be displayed at the display 306 for presentation e.g. under the control of another/specialised processor directly responsible for generating the display presentation.

Some applications only contain video/graphics information, such as teletext or games, others only audio information, and others again contain both video and audio information. The description given above of embodiments of the invention is intended to cover all these types of applications.

In some cases, it could be preferred that side-by-side windows (split screen) has equal importance, e.g. when to users are watching different contents. Audio information related to the applications in the windows can be distributed via headphones. In this case, the last opened window can be the window containing the application with current user focus. Through manual settings plus the learning function, the system can be programmed to understand the equal importance for this specific case.

For easy representation of active and non-active windows, a window frame can be marked by colours with optional different saturations. The active window can be selected by coloured buttons representing the window colours on a remote control. The active window should automatically stay on top of other windows. The colour of the active window should indicate that this window has user focus, which can be done with higher saturated colours compared to the other windows.

Though the invention has been described with application(s) with current focus of a user, it is to be understood that the method works even if no user is present.

1. A method of allocating shared resources between applications with media information on a resource limited platform, characterized in that the method comprises the following steps:
identifying an application with a current focus of a user;
setting or increasing the output quality of the application with the current focus of the user;
automatically allocating a remaining part of the resources to at least one application without the current focus of the user.

2. A method according to claim 1, characterized in that the step of identifying the application with the current focus of the user is selected from at least one of the group of: user controlled, system controlled, or externally controlled.

3. A method according to claim 2, characterized in that the user controlled step of identifying the application with the current focus of the user, comprises one or more of the following steps:
selecting a new application as the application with the current focus of the user, when the new application is opened;
changing the application with the current focus of the user to an application just switched to upon switching to an already opened application;
when the user closes down an application with the current focus, switching to the application with the preceding focus of the user by keeping a record of the order of previously opened applications to indicate their importance in decreasing order, where the most recently opened application has the highest importance.

4. A method according to claim 2, characterized in that the system controlled step of identifying the application with the current focus of the user, is performed by one of the following steps:
an automatically changing of the current focus of the user according to a predetermined priority hierarchy of the available applications;
keeping a record of the order of previously opened applications to indicate their importance in decreasing order, where the most recently opened application has the highest importance and, switching to the application with the preceding focus of the user when the user closes down an application with the current focus.

5. A method according to claim 2, characterized in that a provider of the media information performs the externally controlled step of identifying the application with the current focus of the user.

6. A method according to claim 1, characterized in that the step of setting or increasing the output quality of the application with current focus of the user is performed automatically by means of automatic settings of the overall system control and with no additional input from the user.

7. A method according to claim 1, characterized in the step of decreasing or increasing the output quality of the application with the current focus of the user is performed manually by user interaction by means of a user interface.

8. A method according to claim 6, characterized in that the automatic settings of the overall system control is influenced by a learning function, which takes previous user settings of the past into account.

9. A system for allocating shared resources between applications with media information on a resource limited platform, characterized in that the system comprises:
means for identifying an application with a current focus of a user;
means for setting or increasing the output quality of the application with the current focus of the user;
means for automatically allocating a remaining part of the resources to at least one application without the current focus of the user.

10. A system according to claim 9, characterized in that the means for identifying the application with the current focus of the user is selected from at least one of the group of: user controlled means, system controlled means, or externally controlled means.

11. A system according to claim 10, characterized in that the user controlled means for identification of the application with the current focus of the user, comprises one or more of the following:
means for selecting a new application as the application with the current focus of the user, when the new application is opened;
means for changing the application with the current focus of the user to an application just switched to upon switching to an already opened application;
means for switching to the application with the preceding focus of the user, when the user closes down an application with the current focus, and
means for keeping a record of the order of previously opened applications to indicate their importance in decreasing order, where the most recently opened application has the highest importance.

12. A system according to claim 10, characterized in that the means for system controlled identification of the application with the current focus of the user, comprises:
means for automatical changing of the current focus of the user according to a predetermined priority hierarchy of the available applications;
means for keeping a record of the order of previously opened applications to indicate their importance in decreasing order, where the most recently opened application has the highest importance, and
means for switching to the application with the preceding focus of the user when the user closes down an application with the current focus.

13. A system according to claim 10, characterized in that a provider of the media information performs the externally controlled step of identifying the application with the current focus of the user.

14. A system according to claim 9, characterized in that the means for setting or increasing the output quality of the application with current focus of the user is activated automatically and with no additional input from the user.

15. A system according to the claim 9, characterized in that the means for decreasing or increasing the output quality of the application with the current focus of the user is activated manually by user interaction by means of a user interface.

16. A system according to claim 9, characterized in that the automatic settings of the overall system control is influenced by a learning function, which takes previous user settings of the past into account.
